(19) United States
(12) Patent Application Publication
(10) Pub. No.: US 2025/0298234 A1
(43) Pub. Date: Sep. 25, 2025

(54) Sample stage system for a microscope and microscope

(71) Applicant: Carl Zeiss Microscopy GmbH, Jena (DE)

(72) Inventors: Jakob Haarstrich, Jena (DE); Alexander Scheps, Adelebsen (DE); Ralph Lange, Jena (DE); Philipp Holz, Jena (DE)

(21) Appl. No.: 19/083,920

(22) Filed: Mar. 19, 2025

(30) Foreign Application Priority Data
Mar. 24, 2024 (DE) 10 2024 108 374.3

(51) Int. Cl. G02B 21/26; G02B 21/00

(52) U.S. Cl. CPC G02B 21/26; G02B 21/0088

(57) ABSTRACT

A sample stage system and a microscope including a sample stage, a holding frame for receiving a sample, wherein an axial spatial direction is given by a normal direction of a plane of extent of the holding frame. The holding frame is set up for being arranged on the sample stage either alone or together with a mechanical adapter component or together with a mechanical functional component for the mechanical manipulation of the holding frame, wherein, at least for an initial position of the mechanical functional component, an axial height of the holding frame relative to the sample stage is the same regardless of whether the holding frame is arranged on the sample stage on its own or together with the mechanical adapter component or with the mechanical functional component.

The current application claims the benefit of German Patent Application No. 10 2024 108 374.3, filed on Mar. 24, 2024, which is hereby incorporated by reference.

The invention relates to a sample stage system for a microscope according to the preamble of Claim 1. In a further aspect, the invention relates to a microscope with a sample stage system.

A sample stage system of the type in question for a microscope has the following components: a sample stage, a holding frame for receiving a sample, wherein the holding frame is set up for being arranged on the sample stage and wherein an axial spatial direction is given by a normal direction of a plane of extent of the holding frame. Such sample stage systems are known in many variants.

Modern modular, flexible microscopes usually have motorized or manually operated x-y sample stages that allow the sample to be moved laterally to bring desired areas of the sample into the field of view. Because the sample stages are comparatively expensive and the samples examined with these microscopes are very varied, a common concept is that, for adaptation to a sample stage, holding frames are inserted into the sample stage, providing a suitable support or receptacle for the respective samples and sample carriers. The main advantage of such holding frames is that, for different samples, only the holding frame and not the sample stage has to be changed. There is a mechanical interface between the sample stage and the inserted or attached holding frame.

In addition, however, on microscope systems additional modules that provide functional enhancements of an actuator are often also attached to the sample stage, for example screwed on. Examples of such additional modules are for example z-axis vertical stages, which allow movements of the x-y stage in the direction of the z axis, usually with piezo actuators, and/or levelling attachments, with which for example two additional tilt axes are provided for a holding frame. In such cases, the holding frame that receives the sample must engage the new additional module and should no longer be in contact with the x-y stage itself, in order not to hinder the mechanical function of the additional module.

The following solutions are known for the task of applying samples to a sample stage on the one hand and an actuator module or additional module on the other hand.

In a first known technical solution, the additional module has a different mechanical interface than the sample stage. Special holding frames, which are used for inserting the samples when the additional module is to be used, are then provided for this additional interface. Separate holding frames for the additional module must therefore in each case be developed and kept available.

A second solution is notable in that the additional module has the same mechanical interface as the sample stage. This allows the same holding frame to be used as when directly mounting the holding frame in or on the stage. However, it is not possible here to achieve the same sample support plane. If the additional module is screwed onto the sample stage and has the same interface, then this interface must necessarily also be on top. As a result, the sample is also higher and less accessible from below with the objectives (or the condenser in the upright microscope). This difference can be up to several mm in today's known solutions.

An object of the invention can be considered that of providing a sample stage system which is particularly comfortable for a user to operate and requires less adjustment effort compared to the prior art.

This object is achieved by the sample stage system having the features of Claim 1. A microscope with a sample stage system according to the invention is also claimed.

Advantageous configurations of the sample stage system according to the invention are explained below, in particular in connection with the dependent claims and the figures.

The sample stage system of the type specified above is developed according to the invention by providing that the holding frame is set up for being arranged on the sample stage either together with a mechanical adapter component or together with a mechanical functional component for the mechanical manipulation of the holding frame, wherein, at least for an initial position of the mechanical functional component, an axial height of the holding frame relative to the sample stage is the same regardless of whether the holding frame is arranged on the sample stage with the mechanical adapter component or with the mechanical functional component, or that the holding frame is set up for being arranged on the sample stage either on its own or together with a mechanical functional component for the mechanical manipulation of the holding frame, wherein, at least for an initial position of the mechanical functional component, an axial height of the holding frame relative to the sample stage is the same regardless of whether the holding frame is arranged on the sample stage on its own or together with the mechanical functional component.

Typically, the sample stage may be an x-y translation stage or an x-y-z translation stage. This means that the sample stage can in each case be moved independently in the direction of the x and y coordinates or in the direction of the x, y and z coordinates, for example by means of precise screw drives, by adjusting motors or else manually. The z direction is typically the direction of the optical axis of the microscope objective. From the perspective of a user sitting in front of the microscope, the left-right direction is typically defined as the x direction. From the perspective of this user, the y direction is then the front-back direction.

The term holding frame refers to a mechanical arrangement which can receive typical sample carriers, such as microscope slides or Petri dishes, and is suitable for being connected to the sample stage in a defined way. Typically, both the sample stage and the holding frame essentially have the shape of rectangles, the sides of which are arranged substantially parallel in a designated working state. However, this is not mandatory. For example, it would also be possible that the holding frame has the shape of a circular ring, which is received in a then also annular recess of the sample stage.

An essential idea of the present invention can be considered that the same mechanical interfaces are provided on the sample stage and the mechanical functional component, which may also be referred to as an additional module, add-on component, additional component, additional actuator module or actuator module, so that, regardless of whether or not the additional mechanical component is used, the same holding frame can be used.

Another important idea of the present invention can be seen in the fact that, regardless of whether or not the additional mechanical component is used, the same mounting height is in each case achieved for the holding frame. A sample carrier arranged on the holding frame, for example a Petri dish or a microscope slide, is thus at the same height regardless of whether or not the additional mechanical component is used.

A first important advantage of the invention is that the user can use the same holding frame when using the mechanical functional component as when using the sample stage directly. This means that fewer components have to be kept available for work with the microscope and cost advantages are possible. The latter may be important in particular because more complex and expensive modules such as table incubators are also installed at the mechanical interface.

Another advantage of the holding frame which can be used with and without the functional component is that the number of components to be developed and kept available can be reduced.

Finally, an important advantage of the invention is that the number of components is reduced and that at the same time very good sample availability is possible.

The mechanical functional component and the mechanical adapter component are usually located between the holding frame and the sample stage.

With regard to the specific additional functions provided by the mechanical functional component, there is freedom of design. In a first particularly preferred configuration of the sample stage system according to the invention, the mechanical functional component has a z drive for adjusting an axial height of the holding frame above the sample stage. The z drive may for example have a piezo actuator or a plurality of piezo actuators. Alternatively or in addition, it may also be provided that the mechanical functional component has means for varying an orientation of the holding frame relative to the sample stage, for example levelling screws. The levelling screws may be adjustable manually and/or by means of servo motors. Expediently, at least two of the levelling screws may be adjustable, in order to make a tilting of the holding frame relative to the sample stage about two independent axes possible in the case of three-point support.

Another preferred configuration of the sample stage system according to the invention is notable in that the mechanical adapter component is formed by an adapter frame, which is set up to be inserted between the sample stage and the holding frame for adapting an axial height of the holding frame relative to the sample stage. The mechanical adapter component may in particular perform a dummy function or spacer function, in order to achieve in each case one and the same mechanical interface for the holding frame relative to the sample stage as when using for example a mechanical functional component which provides a z-translation function and/or a levelling function. The adapter component may be of a simple nature. For example, the adapter component may have a plurality of parts or be formed from a plurality of parts, for example rods or support bars. These rods may be separate single rods. This means that the adapter component does not necessarily have to be a fully formed frame. For example, the adapter component may be formed by two rods or support bars, which can be inserted into the sample stage and on which the holding frame can then be placed.

The mechanical functional component is preferably configured such that it can be securely connected to the sample stage, for example screwed.

The holding frame may rest on the mechanical functional component or the mechanical adapter component and be held there by gravitational force. Alternatively or in addition, there may be a magnetic connection between the holding frame and the mechanical functional component or the mechanical adapter component.

For example, the holding frame may rest on the sample stage or the mechanical functional component by means of a three-point support. The three-point support may consist of a countersink, a groove and a surface area or three grooves, on the stage or on the mechanical functional component. The contact surfaces on the holding frame which respectively engage in the countersink, the groove or the grooves may at least partially have a spherical shape. These spheres may for example be located at the end of levelling screws, in particular adjustable levelling screws. All three of the levelling screws, but at least two of the levelling screws, may be made adjustable in height, for example as spherical-head screws, in order to allow levelling of the holding frame, i.e. tilting about two axes.

The support points of the three-point support may be adjustable in height, for example by means of servo motors; this means that, for adjusting the contact surfaces on the holding frame, there may be servo motors which can be activated by means of a controller.

The supports on the sample stage may have in particular point-symmetrically opposite the bearings of the three-point support in each case recesses or even clearances or holes, which prevents the spheres from touching down, and thus the mechanical functional components from mechanically shorting, when the holding frame rotates by 180° from the initial position. For this purpose, an exemplary embodiment is described in more detail below.

The holding frame may be fixed on the sample stage or on the mechanical functional component by magnetic forces, but also by just the force of the weight of the holding frame. The holding frame may in particular be arranged such that the force of its weight acts downwards and presses it onto the sample stage or the mechanical functional component. Magnets may be installed on both sides or only on one side of the holding frame interface. It is also possible to install magnets only on one side and only provide magnetizable material on the corresponding other side.

Preferably, the magnets may be installed in the holding frame and not on or in the sample stage or on or in the mechanical functional component. In this way, magnet-free holding frames can also be arranged on the same sample stage or the same mechanical functional component. The magnets may be designed symmetrically in such a way that, when the holding frame rotates, the same magnets still act.

The magnets or the magnetizable material in the holding frame may be formed on the contact surfaces themselves. This allows the magnetic holding force to remain unchanged during levelling.

With regard to the shape of the holding frame and/or openings in the holding frame and/or the sample stage, there is freedom of design. Preferred variants of the sample stage system according to the invention are notable in that the holding frame and/or an opening in the holding frame, in the sample stage, in the mechanical adapter component and/or the mechanical functional component is circular-disc-shaped, rectangular, in particular square, or has the form of a, in particular regular, polygon. This means that all common sample holders and sample carriers can be used.

An essential idea of the present invention, as explained above, is to use one and the same holding frame regardless of whether or not an actuator module is used. Advantageous configurations of the sample stage system according to the invention additionally make use of the concept that a holding frame can be used in different positions relative to the sample stage and a possibly present mechanical functional component. For this purpose, it may be preferred if on opposite sides on the holding frame there are formed at least three, in particular outwardly projecting, holding areas, which are set up to engage either only with support surfaces formed on the sample stage or only with support surfaces formed on the mechanical functional component. The holding areas may for example extend outwards in a plane of extent of the holding frame. The holding areas may be in particular holding lugs.

It is also advantageous if the holding frame is rectangular and has a different number of holding areas respectively on opposite sides. This unsymmetrical arrangement of the holding areas allows the holding frame to be arranged in different positions on the sample stage. For example, a holding area or several, in particular two, holding areas on one side of the holding frame may be arranged respectively offset relative to several, in particular two, holding areas or a holding area on a respectively opposite side of the holding frame. An offset arrangement refers here to an arrangement offset in the direction of extent of the side concerned.

In a preferred configuration, three-point supports are achieved in each case, that is to say on two adjacent sides of the holding frame there is in each case a holding area and on the opposite sides of the holding frame respectively there are in each case two holding areas.

An overall set of support surfaces on the sample stage and support surfaces on the mechanical functional component may advantageously have a rotational symmetry of at least two counts with respect to an axis of rotation parallel to the axial direction. This can achieve the effect that the holding frame can be arranged on the sample stage or the mechanical functional component in two different rotational positions, which is further explained in detail below. Specifically, the holding frame in the second position may be arranged in comparison with the first position rotated about an axis of rotation parallel to the axial spatial direction, in particular by an angle of 180°.

Advantageously, when there is a mechanical functional component attached to the sample stage, the holding frame in a first position may rest with its holding areas exclusively on support surfaces of the sample stage and the holding frame in a second position may rest with its holding areas exclusively on support surfaces of the mechanical functional component, wherein, at least in an initial position of the mechanical functional component, an axial height of the holding frame relative to the sample stage in the first position and in the second position is the same in each case.

The support surfaces in the sample stage and/or in the mechanical functional component may in each case be formed by magnets or have magnets or magnetic material. The support surfaces of the sample stage may for example be formed as raised areas on the sample stage.

In a preferred configuration of the sample stage system according to the invention, the support surfaces on the sample stage and the support surfaces on the mechanical functional component each have the same axial height relative to an underside of the sample stage when the mechanical functional component is arranged as intended on the sample stage. The holding areas or holding lugs can then be of a relatively simple form.

However, it may be that the same axial heights of the support surfaces on the sample stage and the support surfaces on the mechanical functional component cannot be achieved. In this case, in which the support surfaces on the sample stage and the support surfaces on the mechanical functional component have a different axial height relative to an underside of the sample stage when the mechanical functional component is arranged as intended on the sample stage, it is expedient if the holding areas each have two support surfaces separated by a step in the axial direction. A difference in height between the support surfaces on the sample stage and the support surfaces on the mechanical functional component is advantageously equal to a height of the steps of the holding areas. This allows the same mounting height to be achieved again regardless of whether the holding frame rests on the mechanical functional component or the sample stage.

Further advantages and features of the present invention are described below in connection with the appended figures, in which:

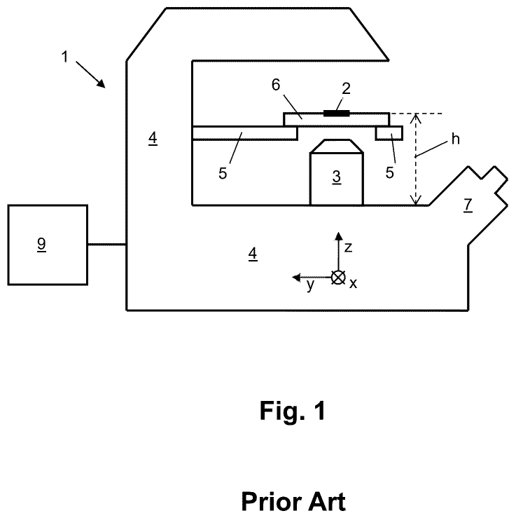

FIG. 1: shows a microscope according to the prior art;

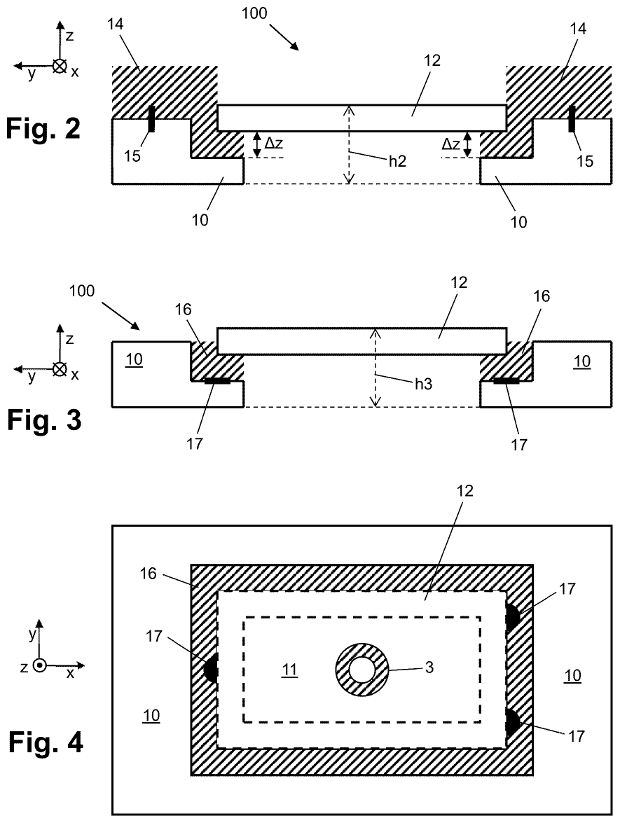

FIGS. 2 to 4: show a first exemplary embodiment of a system according to the invention;

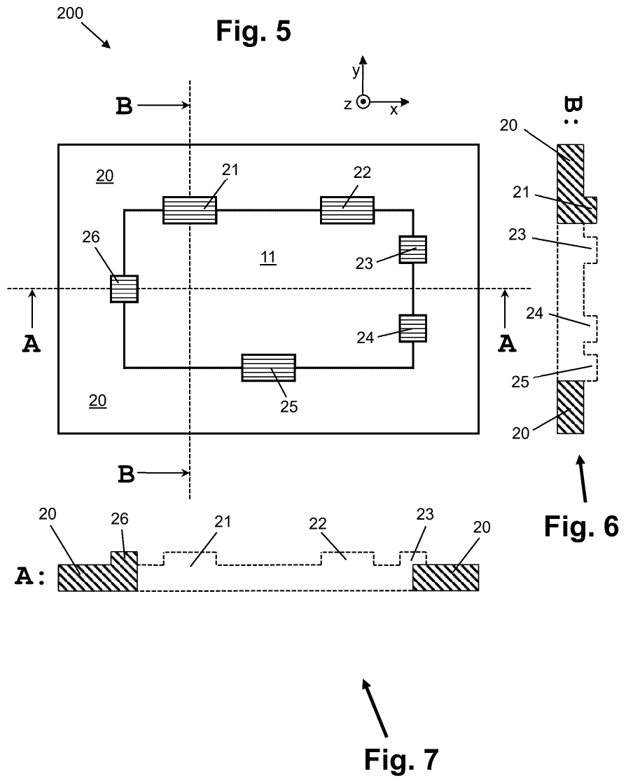

FIGS. 5 to 7: show an exemplary embodiment a sample stage for a second exemplary embodiment of a system according to the invention;

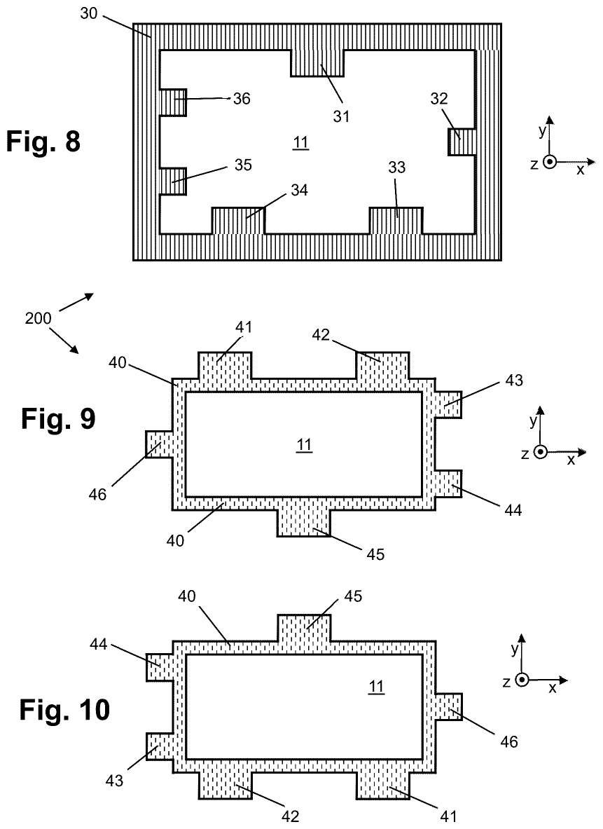

FIG. 8: shows a mechanical functional component for the second exemplary embodiment of the system according to the invention;

FIGS. 9 and 10: show a holding frame for the second exemplary embodiment of the system according to the invention;

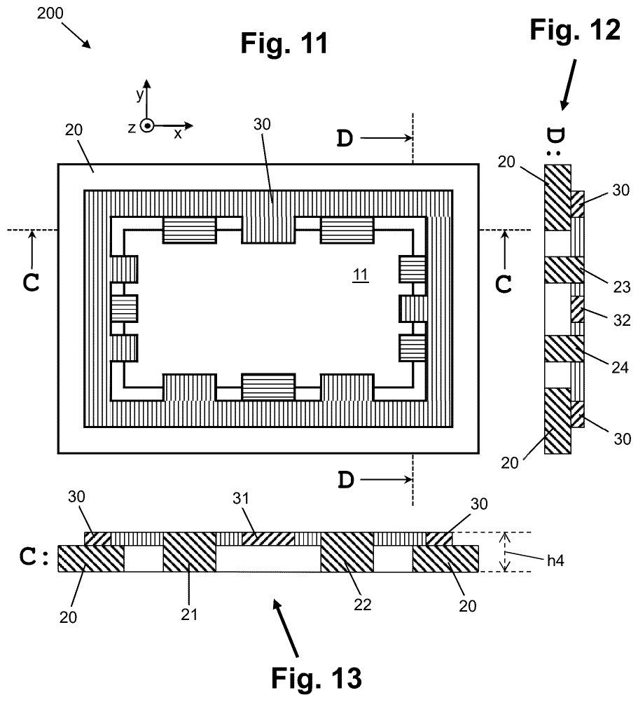

FIGS. 11 to 13: show an arrangement of the holding frame on the sample stage in the second exemplary embodiment of the system according to the invention;

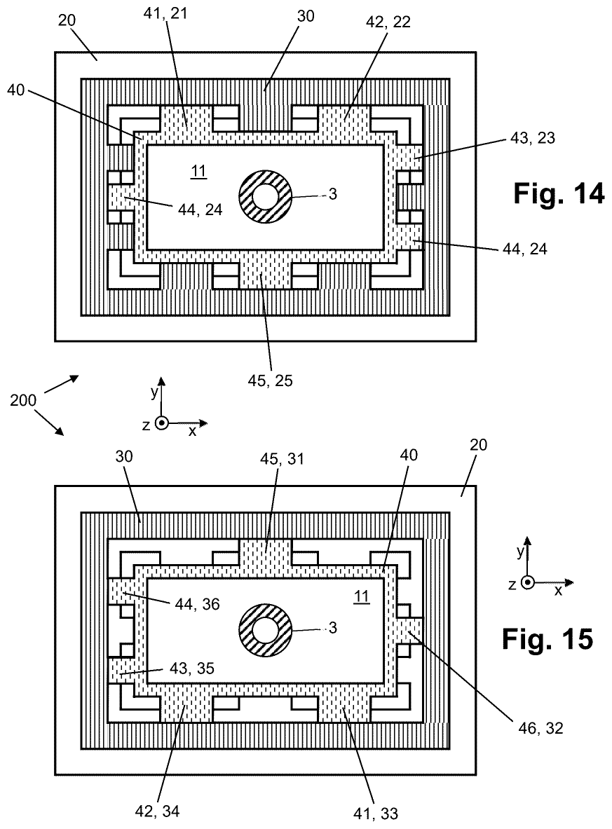

FIG. 14: shows an arrangement of the holding frame exclusively on the sample stage in the second exemplary embodiment of the system according to the invention;

FIG. 15: shows an arrangement of the holding frame exclusively on the mechanical functional component in the second exemplary embodiment of the system according to the invention;

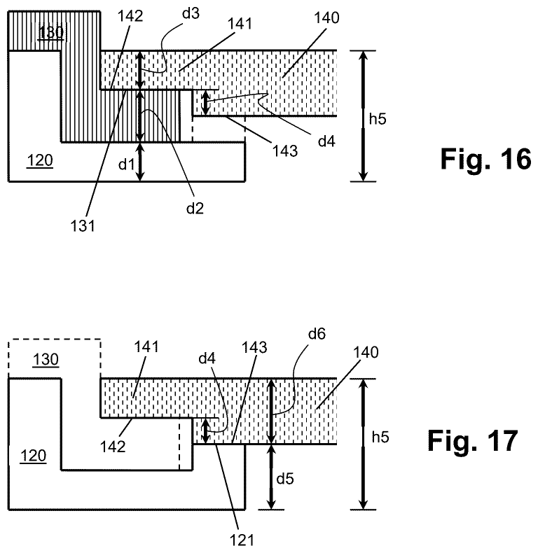

FIG. 16: shows a sectioned partial view of an exemplary embodiment of holding lugs with stepped support surfaces; and

FIG. 17: shows a further sectioned partial view of the exemplary embodiment from FIG. 16 from another sectional plane.

Components that are the same or act in the same way are generally identified in each case by the same reference signs in the figures.

FIG. 1 schematically shows a microscope of the prior art. This microscope has as essential components a microscope stand 4, a sample stage 5 attached to the microscope stand 4, a microscope objective 3 and a holding frame 6, which rests on the sample stage 5. Arranged on the holding frame 6 is a sample 2, which may be for example a microscope slide or a Petri dish. An eyepiece is schematically shown with the reference numeral 7.

An axial direction z is given by a normal direction to a plane of extent of the holding frame 6. It runs substantially parallel to an optical axis of the microscope objective 3.

Finally, there is a controller 9, which can be used for example to make adjustments of the sample stage 5 and optionally of the holding frame 6, and to read out and process microscopic measurement data, for example of a camera not shown in FIG. 1.

The microscope 1 shown in FIG. 1 is an inverted microscope, i.e. the microscope objective 3 is directed onto the sample 2 on the holding frame 6 from below.

A vertical distance, that is to say a distance in the z direction, of an upper side of the holding frame 6 from a reference surface on the microscope stand 4 is denoted by h.

A first exemplary embodiment of a sample stage system 100 according to the invention is explained with reference to FIGS. 2 to 4. FIG. 2 shows an arrangement of a holding frame 12 on a sample stage 10 together with a mechanical functional component 14. FIG. 3 shows the arrangement of the same holding frame 12 on the same sample stage 10, but now using a mechanical adapter component 16. FIG. 4 shows a view of the arrangement of FIG. 3 from above, i.e. in the direction of the negative y direction. A coordinate system is indicated in each of the figures.

The mechanical functional component 14 schematically shown in FIG. 2 is a z drive, which may for example have piezo actuators, which are not shown in the figure but with which, as illustrated by the double arrow Δz, an adjustment of the holding frame 12 in the direction of the z axis is possible. In the situation schematically shown in FIG. 2, the z drive 14 is intended to be in an initial position, which in particular can be a middle position or the lowest possible position of the z drive 14. The holding frame 12 rests on the z drive 14, which for its part is secured to the sample stage 10 with screws 15. An axial height between an upper side of the holding frame 12 and an underside of the sample stage 10 is schematically illustrated in FIG. 2 by the double arrow h2.

In FIG. 3, instead of the z drive 14 there is a mechanical adapter component 16, which is formed as an adapter frame. The holding frame 12 is inserted in this adapter frame 16. The adapter frame 16 is essentially only used to provide between an upper side of the holding frame 12 and an underside of the sample stage 10 an axial height h3 which is equal to the axial height h2 in the installation situation of FIG. 2. In the example shown in FIG. 3, the adapter frame 16 is fixed on or in the sample stage 10 by means of magnetic connections 17. It is also possible that, in addition to gravitational force, the holding frame 12 is held on or in the z drive 14 and the adapter frame 16 in each case by means of magnetic connections.

FIG. 4 schematically shows that the sample stage 10, the adapter frame 16 and the holding frame 12 each have an opening 11, through which the microscope objective 3 can be directed onto a sample arranged on the holding frame 12, for example in a Petri dish or on a microscope slide.

It is essential for this example of the present invention that the receptacles in the mechanical functional component 14, formed as a z drive, and the mechanical adapter component 16, formed as an adapter frame, for the holding frame 12 are in each case identical, so that the same holding frame 12 can be used for the two installation situations of FIGS. 2 and 3 respectively. In addition, the essential advantage is achieved that, at least for an initial position of the z drive, the height of the holding frame 12 with respect to the underside of the sample stage 10 is the same, i.e., h2=h3, regardless of whether the z drive 14 or the adapter frame 16 is used. The receptacles in the mechanical functional components 14 and the mechanical adapter component 16 may also be referred to as mechanical interfaces.

A second exemplary embodiment of a sample stage system 200 according to the invention is explained with reference to FIGS. 5 to 15. An essential aspect in this exemplary embodiment is that a holding frame can be positioned in different positions relative to the sample stage and that as a result the holding frame rests either only on the sample stage or only on a mechanical functional component. Specifically:

FIG. 5 schematically shows a sample stage 20 in a plan view. FIGS. 6 and 7 are sectional views of this sample stage 20 along the sectional lines A-A (FIG. 7) and B-B (FIG. 6) entered in FIG. 5. The sample stage 20 has a plurality of support surfaces 21 to 26, which are arranged asymmetrically on the sides of the through-opening 11. As can be seen in part from the sectional views of FIGS. 6 and 7, these support surfaces 21 to 26 are formed as raised surfaces above the remaining surface of the sample stage 20.

FIG. 8 shows a mechanical functional component 30, which can be placed on the sample stage 20 shown in FIG. 5. For example, in a way similar to that shown in FIG. 2, the mechanical functional component 30 can be screwed onto the sample stage 20. In the example shown, the mechanical functional component 30 is again to be configured as a z drive, although FIG. 8 and the further figures do not contain any details regarding this functionality. The z drive 30 has support surfaces 31 to 36 facing inwards, i.e. in the direction of the through-opening 11, which are arranged rotated by 180° in comparison with the support surfaces 21 to 26 of the sample stage 20.

FIGS. 9 and 10 show a holding frame 40 for use with the sample stage 20 of FIGS. 5 to 7 and the mechanical functional component 30, i.e. the z drive, of FIG. 8. The holding frame 40 has in its plane of extent holding areas 41 to 46, which are formed as outwardly projecting holding lugs 41 to 46 and the arrangement of which corresponds to that of the support surfaces 21 to 26 of the sample stage 20 on the one hand and the arrangement of the support surfaces 31 to 36 of the z drive 30 on the other hand. FIG. 10 shows the same holding frame as FIG. 9, but in a position rotated by 180° about an axis of rotation parallel to the z direction.

In FIGS. 11 to 13, the sample stage 20 is then illustrated with a mechanical functional component 30 arranged on it, i.e. with the z drive 30. FIG. 11 shows a plan view in the direction of the negative z axis and FIGS. 12 and 13 respectively show sectional views along the sectional lines C-C (FIG. 13) and D-D (FIG. 12) entered in FIG. 11. As can be seen in part, the support surfaces 21 to 26 of the sample stage 20 and the support surfaces 31 to 36 of the z drive each have the same axial height, which is illustrated by the double arrow h4.

FIG. 14 then shows in a plan view the arrangement of the holding frame 40 such that the holding lugs 41 to 46 of the holding frame 40 rest exclusively on the support surfaces 21 to 26 of the sample stage 20. It is therefore not possible in this situation to adjust the holding frame 40 in the z direction with the z drive 30.

Finally, FIG. 15 shows an arrangement in which the holding frame 40 is rotated by 180° about an axis of rotation parallel to the z direction in comparison with the situation of FIG. 14, and then rests exclusively on the support surfaces 31 to 36 of the z drive 30. This means that, in the situation of FIG. 15, an adjustment of the holding frame 40 in the z direction with the z drive 30 is possible.

A variant of the second exemplary embodiment is explained with reference to FIGS. 16 and 17. This variant relates to a situation in which, unlike that shown in FIG. 13, the support surfaces on the mechanical functional component are not the same height as the support surfaces on the sample stage. In order to take this into account, in the exemplary embodiment illustrated in FIGS. 16 and 17 the holding lugs of a holding frame 140 each have a step. Shown in each of FIGS. 16 and 17 is such a holding lug 141 which, as can be seen, has a step with a height d4, so that two support surfaces 142 and 143 are formed at different heights on this holding lug 41.

In the situations shown in FIG. 16, again a mechanical functional component 130, for example a z drive, is arranged on a sample stage 120, for example screwed. The holding frame 140 rests with the support surface 142 of the holding lug 141 on a support surface 131 of the mechanical functional component 130. This achieves a height h5 of the holding frame 140 above the underside of the sample stage 120 which, as illustrated in FIG. 16, is made up of the components d1, d2 and d3.

FIG. 17 shows a sectional view through another plane and the holding frame 140 is rotated in comparison with the situation of FIG. 16, according to the situations in FIGS. 14 and 15. The holding frame 140 then only rests with supports 143 of the holding lugs 141 on the support surfaces of the sample stage 120. FIG. 17 shows an example of such a support surface 121. The height of the step d4 of the holding lugs is formed just so that the distances d5 and d6 again achieve the same height h5 as in FIG. 16, where the holding frame 140 rests only on the support surfaces of the mechanical functional component 130, i.e.:

$$d 1 + d 2 + d 3 = d 5 + d 6 = h 5$$

The present invention provides a novel sample stage system for which fewer parts have to be kept available, because an additional module, thus a mechanical functional component, does not require a separate holding frame to be developed in each case. Providing multiple parts on fewer components also allows manufacturing costs to be saved. Furthermore, the development effort is less because the uniform sample height that can be achieved means that there is no need for specific translational clearances to be observed.

An essential aspect is therefore that the customer can use the same holding frame both with a sample stage and with a mechanical functional component, i.e. an additional component, and consequently only has to pay for one holding frame.

The mechanical interface, i.e. the sample support plane, can be the same regardless of whether or not an additional module or a mechanical functional component is used.

The use of an additional component therefore does not result in any restrictions on sample accessibility in comparison with operation without such an additional component.

Finally, the second exemplary embodiment described above also provides a variant in which changing between the use of a holding frame directly on the sample stage or with a mechanical functional component is easily possible for the customer without any modification or tools.

### LIST OF REFERENCE SIGNS

1 Microscope
2 Sample
3 Microscope objective
4 Microscope stand
5 Sample stage, x-y translation stage
6 Holding frame
7 Eyepiece
9 Control unit
10 Sample stage, x-y translation stage
11 Opening in holding frame 12, 40, adapter frame 16, 30, z drive 14, sample stage 10, 20
12 Holding frame
14 Mechanical functional component, z drive
15 Screws
16 Mechanical adapter component, adapter frame
17 Magnetic connection
20 Sample stage
21-26 Support surfaces on sample stage 20
30 Mechanical functional component, z drive
31-36 Support surfaces on z drive 30
40 Holding frame
41-46 Holding areas, holding lugs on holding frame 40
100 System according to the invention
120 Sample stage
121 Support surface on sample stage 120
130 Mechanical functional component, z drive
131 Support surface on mechanical functional component 130
140 Holding frame
141 Holding lug on holding frame 140
142 First support surface on holding lug 141
143 Second support surface on holding lug 141
200 System according to the invention
A Sectional line
B Sectional line
C Sectional line
D Sectional line
d1 Thickness of the sample stage 120
d2 Thickness of the mechanical functional component 130
d3 Thickness of the holding frame 140 in the area of the support surface 142
d4 Axial height of step between support surfaces 142 and 143
Axial distance from the underside of the sample stage 120 to the upper side d5 of the support surface 121 of the sample stage 120
d6 Thickness of the holding frame 140
h Axial distance from reference point on stand 4 to upper edge of holding frame 6
h2 Axial distance between underside of sample stage 10 and upper side of holding frame 12 when using functional component 14
h3 Axial distance from underside of sample stage 10 to upper side of holding frame 12 when using adapter component 16
h4 Axial distance from underside of sample stage 20 to upper side of the support surfaces 21 to 26 and 31 to 36 respectively
h5 Axial distance of the upper side of the holding frame 140 above the underside of the sample stage 120
x, y, Z Right-handed coordinate system
Z Direction of the optical axis
Δz Variability in z direction by actuating z drive 14

1. Sample stage system for a microscope, the sample stage system comprising:
a sample stage,
a holding frame for receiving a sample, wherein the holding frame is set up for being arranged on the sample stage and wherein an axial spatial direction is given by a normal direction of a plane of extent of the holding frame,
wherein the holding frame is set up for being arranged on the sample stage either together with a mechanical adapter component or together with a mechanical functional component for the mechanical manipulation of the holding frame,
wherein, at least for an initial position of the mechanical functional component, an axial height of the holding frame relative to the sample stage is the same regardless of whether the holding frame is arranged on the sample stage with the mechanical adapter component or with the mechanical functional component or
wherein the holding frame is set up for being arranged on the sample stage either on its own or together with a mechanical functional component for the mechanical manipulation of the holding frame,
wherein, at least for an initial position of the mechanical functional component, an axial height of the holding frame relative to the sample stage is the same regardless of whether the holding frame is arranged on the sample stage on its own or together with the mechanical functional component.

2. Sample stage system according to claim 1,
wherein the mechanical adapter component is formed by an adapter frame, which is set up to be inserted between the sample stage and the holding frame for adapting an axial height of the holding frame relative to the sample stage.

3. Sample stage system according to claim 2,
wherein the adapter frame has a plurality of parts or is formed by a plurality of parts.

4. Sample stage system according of claim 1,
wherein the mechanical functional component has a z drive for adjusting an axial height of the holding frame above the sample stage.

5. Sample stage system according to claim 1,
wherein the mechanical functional component has means for varying an orientation of the holding frame relative to the sample stage.

6. Sample stage system according to claim 1,
wherein the mechanical functional component can be securely connected to the sample stage.

7. Sample stage system according to claim 1,
wherein the holding frame rests on the mechanical functional component or the mechanical adapter component and is held there by gravitational force.

8. Sample stage system according to claim 1,
wherein there is a magnetic connection between the holding frame and the mechanical functional component or the mechanical adapter component.

9. Sample stage system according to claim 1,
wherein the holding frame and/or an opening in the holding frame, in the sample stage, in the mechanical adapter component and/or the mechanical functional component is circular-disc-shaped, rectangular, or has the form of a polygon.

10. Sample stage system according to claim 1,
wherein on opposite sides on the holding frame there are formed at least three holding areas, which are set up to engage either only with support surfaces formed on the sample stage or only with support surfaces formed on the mechanical functional component.

11. Sample stage system according to claim 10,
wherein the holding areas extend outwards in a plane of extent of the holding frame.

12. Sample stage system according to claim 10,
wherein the holding frame is rectangular and has a different number of holding areas respectively on opposite sides.

13. Sample stage system according to claim 10,
wherein a holding area or holding areas on one side of the holding frame are arranged respectively offset relative to holding areas or a holding area on a respectively opposite side of the holding frame.

14. Sample stage system according to claim 10,
wherein an overall set of support surfaces on the sample stage and support surfaces on the mechanical functional component has a rotational symmetry of at least two counts with respect to an axis of rotation parallel to the axial direction.

15. Sample stage system according to claim 10,
wherein, when there is a mechanical functional component attached to the sample stage, the holding frame in a first position rests with its holding areas exclusively on support surfaces of the sample stage and
wherein the holding frame in a second position rests with its holding areas exclusively on support surfaces of the mechanical functional component,
wherein, at least in an initial position of the mechanical functional component, an axial height of the holding frame relative to the sample stage in the first position and in the second position is the same in each case.

16. Sample stage system according to claim 10,
wherein the holding frame in the second position is arranged in comparison with the first position rotated about an axis of rotation parallel to the axial spatial direction.

17. Sample stage system according to claim 10,
wherein the support surfaces in the sample stage and/or in the mechanical functional component are formed by magnets or have magnets.

18. Sample stage system according to claim 10,
wherein the support surfaces of the sample stage are formed as raised areas on the sample stage.

19. Sample stage system according to claim 10,
wherein the support surfaces on the sample stage and the support surfaces on the mechanical functional component have the same axial height relative to an underside of the sample stage when the mechanical functional component is arranged as intended on the sample stage.

20. Sample stage system according to claim 10,
wherein the support surfaces on the sample stage and the support surfaces on the mechanical functional component have a different axial height relative to an underside of the sample stage when the mechanical functional component is arranged as intended on the sample stage.

21. Sample stage system according to claim 20,
wherein the holding areas each have two support surfaces separated by a step in the axial direction.

22. Sample stage system according to claim 20,
wherein a difference in height between the support surfaces on the sample stage and the support surfaces on the mechanical functional component is equal to a height of the steps of the holding areas.

23. Microscope with a sample stage system according to claim 1.

24. Microscope according to claim 23,
which is formed as an inverted microscope.
